(19) United States
(12) Patent Application Publication
(10) Pub. No.: US 2026/0156076 A1
(43) Pub. Date: Jun. 4, 2026

(54) NODE ADDRESS CONFIGURATION METHOD FOR A MULTI-NODE SYSTEM

(71) Applicant: NOREL SYSTEMS LIMITED, Tianjin (CN)

(72) Inventors: Yuanlong WANG, Tianjin (CN); Ke LIANG, Tianjin (CN); Hui WANG, Tianjin (CN)

(21) Appl. No.: 19/456,563

(22) Filed: Jan. 22, 2026

Related U.S. Application Data
(63) Continuation of application No. PCT/CN2024/095157, filed on May 24, 2024.

(30) Foreign Application Priority Data
Jul. 26, 2023 (CN) 202310922761.1

(51) Int. Cl. H04L 45/745; H04L 45/24

(52) U.S. Cl. CPC H04L 45/745; H04L 45/24

(57) ABSTRACT

Disclosed is a node address configuration method for a multi-node system. The multi-node system includes an address controller connected to one or more nodes. The address controller sends an address configuration command packet to the nodes connected to it, and the address configuration command packet includes a target node address and a target node configuration address. A node parses the address configuration command packet: if the target node address in the address configuration command packet is equal to the address identifier of the node, the node configures its address identifier as the target node configuration address; if the target node address is not equal to the address identifier of the node and the node includes a forwarding table, the node queries the forwarding table using the target node address and sends the address configuration command packet to the connected node through the transmission channel indicated by the forwarding table.

### CROSS-REFERENCE TO RELATED APPLICATION

This application is a continuation application of International Patent Application No. PCT/CN 2024/095157, filed on May 24, 2024, which itself claims priority to and benefit of Chinese Patent Application No. 202310922761.1 filed on Jul. 26, 2023 in the State Intellectual Property Office of P. R. China. The disclosure of each of the above applications is incorporated herein by reference in its entirety.

### TECHNICAL FIELD

The present invention relates to the field of communication technology and automotive electronic technology, and in particular to a node address configuration method for a multi-node system.

### BACKGROUND ART

In the field of communication technology, especially in the field of automotive electronics, an intelligent automobile is equipped with more than a dozen or even dozens of high-definition cameras. A common automotive video transmission system works by encoding the digital signal output by a control terminal (Sensor/Image Signal Processor, ISP) into a serial data stream, transmitting it to a receiving terminal through a high-speed Serializer/Deserializer (Serdes), and the receiving terminal decodes it to restore parallel data and sends it to a main control System on Chip (SOC).

Numerous control terminals and receiving terminals require an address configuration method to safely and reliably manage audio-visual and control data streams.

### SUMMARY

The technical problem to be solved by the present invention is how to conveniently configure the addresses of multiple nodes in a multi-node system and accurately locate the target node during data transmission.

To solve the above technical problem, the technical solution of the present invention provides a node address configuration method for a multi-node system.

As a node address configuration method for a multi-node system of the present invention, the multi-node system comprises a plurality of nodes and an address controller. The address controller is connected to one or more nodes and sends an address configuration command packet to the nodes connected to it. The address configuration command packet comprises a target node address and a target node configuration address. Each node in the multi-node system is connected to one or more transmission channels and is linked to one or more other nodes through the transmission channels, where each transmission channel has a transmission channel number. The node includes an address identifier for identifying the address of the node. The node may optionally include a forwarding table, where the input of the forwarding table is a target node address and the output is a transmission channel number. The state of the node comprises an unconfigured state and a configured state. The node parses the address configuration command packet: in the unconfigured state, if the target node address in the address configuration command packet is equal to the address identifier of the node, the node configures its address identifier as the target node configuration address in the address configuration command packet; in the configured state, if the target node address is not equal to the address identifier of the node and the node includes a forwarding table, the node queries the forwarding table using the target node address and sends the address configuration command packet to the connected node through the transmission channel indicated by the forwarding table.

Preferably, in the configured state, if the target node address in the received address configuration command packet is equal to the address identifier of the node, the node configures its address identifier as the target node configuration address in the address configuration command packet.

Preferably, when the address controller has not configured the address identifier of the node, the node is in the unconfigured state; when the address controller completes the configuration of the address identifier of the node, the node is in the configured state.

Preferably, when the address identifier of the node is the default address of the node, the node is in the unconfigured state; when the address identifier of the node is configured to be different from the default address of the node, the node is in the configured state. The default addresses of different nodes in the multi-node system may be the same or different.

Preferably, the method of sending the address configuration command packet to the connected node through the transmission channel indicated by the forwarding table is: if the forwarding table outputs a valid transmission channel number, the address configuration status packet is sent to the connected node through the transmission channel corresponding to the transmission channel number.

Preferably, the address configuration command packet further includes a source node address, where the source node address is the address identifier of the node connected to the address controller.

Further, after receiving the address configuration command packet, the node may optionally return an address configuration status packet. The address configuration status packet comprises a target node address of the address configuration status packet and status information, where the target node address of the address configuration status packet is the source node address of the corresponding address configuration command packet. The node returns the address configuration status packet to the node connected to the address controller, and the node connected to the address controller may optionally return the status information in the address configuration status packet to the address controller connected to it.

In the unconfigured state, if the target node address in the address configuration command packet is equal to the address identifier of the node and the node successfully configures its address identifier as the target node configuration address in the address configuration command packet, the node returns the address configuration status packet with the status information being status information A.

In the unconfigured state, if the target node address in the address configuration command packet is equal to the address identifier of the node and the node fails to configure its address identifier as the target node configuration address in the address configuration command packet, the node returns the address configuration status packet with the status information being status information B.

In the unconfigured state, if the target node address in the address configuration command packet is not equal to the address identifier of the node, the node returns the address configuration status packet with the status information being status information C.

In the configured state, if the target node address in the address configuration command packet is equal to the address identifier of the node and the node successfully configures its address identifier as the target node configuration address in the address configuration command packet, the node returns the address configuration status packet with the status information being status information D.

In the configured state, if the target node address in the address configuration command packet is equal to the address identifier of the node and the node fails to configure its address identifier as the target node configuration address in the address configuration command packet, the node returns the address configuration status packet with the status information being status information E.

In the configured state, if the target node address in the address configuration command packet is not equal to the address identifier of the node and the transmission channel number returned by the node querying the forwarding table using the target node address is invalid, the node returns the address configuration status packet with the status information being status information F.

Preferably, the method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node queries the forwarding table using the target node address in the address configuration status packet and sends the address configuration status packet to the connected node through the transmission channel indicated by the forwarding table.

Preferably, the method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node forwards the address configuration status packet to the transmission channel through which the node received the address configuration command packet corresponding to the address configuration status packet.

Preferably, the node connected to the address controller further includes a timeout timer; when the address configuration status packet is not returned to the node before the timeout, the node stops waiting for the address configuration status packet and may optionally return timeout status information to the address controller connected to it.

Preferably, the address configuration command packet sent by the address controller further includes forwarding table entry configuration information. The node parses the address configuration command packet: in the unconfigured state, if the target node address in the address configuration command packet is equal to the address identifier of the node, the node configures its address identifier as the target node configuration address in the address configuration command packet and configures the corresponding forwarding table entry according to the included forwarding table entry configuration information; in the configured state, if the target node address is not equal to the address identifier of the node, the node queries the forwarding table using the target node address and sends the address configuration command packet to the connected node through the transmission channel indicated by the forwarding table.

Preferably, in the configured state, if the target node address in the address configuration command packet is equal to the address identifier of the node, the node configures its address identifier as the target node configuration address in the address configuration command packet and configures the corresponding forwarding table entry according to the included forwarding table entry configuration information.

Preferably, the address controller may further send a forwarding table configuration command packet, where the forwarding table configuration command packet comprises a target node address and one or more pieces of forwarding table entry configuration information. The node parses the forwarding table configuration command packet: in the unconfigured state, if the target node address in the forwarding table configuration command packet is equal to the address identifier of the node, the node configures the corresponding forwarding table entry according to the forwarding table entry configuration information; in the configured state, if the target node address is not equal to the address identifier of the node, the node queries the forwarding table using the target node address and sends the forwarding table configuration command packet to the connected node through the transmission channel indicated by the forwarding table.

Preferably, in the configured state, if the target node address in the forwarding table configuration command packet is equal to the address identifier of the node, the node configures the corresponding forwarding table entry according to the forwarding table entry configuration information in the forwarding table configuration command packet.

Preferably, the forwarding table configuration command packet further includes a source node address, where the source node address is the address identifier of the node connected to the address controller.

Further, after receiving the forwarding table configuration command packet, the node may optionally return a forwarding table configuration status packet. The forwarding table configuration status packet comprises a target node address of the forwarding table configuration status packet and status information, where the target node address of the forwarding table configuration status packet is the source node address of the corresponding forwarding table configuration command packet. The node returns the forwarding table configuration status packet to the node connected to the address controller, and the node connected to the address controller may optionally return the status information in the forwarding table configuration status packet to the address controller connected to it.

In the unconfigured state, if the target node address in the forwarding table configuration command packet is equal to the address identifier of the node and the node successfully configures the corresponding forwarding table entry according to the forwarding table entry configuration information in the forwarding table configuration command packet, the node returns the forwarding table configuration status packet with the status information being status information A1.

In the unconfigured state, if the target node address in the forwarding table configuration command packet is equal to the address identifier of the node and the node fails to configure the corresponding forwarding table entry according to the forwarding table entry configuration information in the forwarding table configuration command packet, the node returns the forwarding table configuration status packet with the status information being status information B1.

In the unconfigured state, if the target node address in the forwarding table configuration command packet is not equal to the address identifier of the node, the node returns the forwarding table configuration status packet with the status information being status information C1.

In the configured state, if the target node address in the forwarding table configuration command packet is equal to the address identifier of the node and the node successfully configures the corresponding forwarding table entry according to the forwarding table entry configuration information in the forwarding table configuration command packet, the node returns the forwarding table configuration status packet with the status information being status information D1.

In the configured state, if the target node address in the forwarding table configuration command packet is equal to the address identifier of the node and the node fails to configure the corresponding forwarding table entry according to the forwarding table entry configuration information in the forwarding table configuration command packet, the node returns the forwarding table configuration status packet with the status information being status information E1.

In the configured state, if the target node address in the forwarding table configuration command packet is not equal to the address identifier of the node and the transmission channel number returned by the node querying the forwarding table using the target node address is invalid, the node returns the forwarding table configuration status packet with the status information being status information F1.

Preferably, the method of the node returning the forwarding table configuration status packet to the node connected to the address controller is: the node on the return path of the forwarding table configuration status packet parses the forwarding table configuration status packet; if the target node address in the forwarding table configuration status packet is equal to the address identifier of the node, the node receives the forwarding table configuration status packet; if the target node address in the forwarding table configuration status packet is not equal to the address identifier of the node, the node queries the forwarding table using the target node address in the forwarding table configuration status packet and sends the forwarding table configuration status packet to the connected node through the transmission channel indicated by the forwarding table.

Preferably, the method of the node returning the forwarding table configuration status packet to the node connected to the address controller is: the node on the return path of the forwarding table configuration status packet parses the forwarding table configuration status packet; if the target node address in the forwarding table configuration status packet is equal to the address identifier of the node, the node receives the forwarding table configuration status packet; if the target node address in the forwarding table configuration status packet is not equal to the address identifier of the node, the node forwards the forwarding table configuration status packet to the transmission channel through which the node received the forwarding table configuration command packet corresponding to the forwarding table configuration status packet.

Preferably, the node connected to the address controller further includes a timeout timer; when the forwarding table configuration status packet is not returned to the node before the timeout, the node stops waiting for the forwarding table configuration status packet and may optionally return timeout status information to the address controller connected to it.

Preferably, one node is integrated into a single integrated circuit chip.

Preferably, the address controller is connected to one node, and the address controller and the node connected to it are integrated into a single integrated circuit chip.

### BRIEF DESCRIPTION OF DRAWINGS

FIG. 1 is a structural block diagram of a multi-node system of the node address configuration method for a multi-node system of the present invention;

FIG. 2 is a forwarding table when node 1 is in an unconfigured state in a multi-node system of the node address configuration method for a multi-node system of the present invention;

FIG. 3 is an address configuration command packet sent by an address controller in a multi-node system of the node address configuration method for a multi-node system of the present invention;

FIG. 4 is an address configuration status packet returned after a node in an unconfigured state receives an address configuration command packet and successfully completes configuration in a multi-node system of the node address configuration method for a multi-node system of the present invention;

FIG. 5 is a structural block diagram of another multi-node system of the node address configuration method for a multi-node system of the present invention;

FIG. 6A to FIG. 6E are diagrams showing address configuration command packets sent by an address controller in another multi-node system of the node address configuration method for a multi-node system of the present invention;

FIG. 7 is a forwarding table of node 1 after receiving an address configuration command packet and successfully completing configuration in another multi-node system of the node address configuration method for a multi-node system of the present invention;

FIG. 8 is a forwarding table of node 2 after receiving an address configuration command packet and successfully completing configuration in another multi-node system of the node address configuration method for a multi-node system of the present invention;

FIG. 9 is a forwarding table of node 3 after receiving an address configuration command packet and successfully completing configuration in another multi-node system of the node address configuration method for a multi-node system of the present invention;

FIG. 10 is a structural block diagram of yet another multi-node system of the node address configuration method for a multi-node system of the present invention;

FIG. 11A to FIG. 11E are diagrams showing forwarding table configuration command packets and an address configuration command packet sent by an address controller in yet another multi-node system of the node address configuration method for a multi-node system of the present invention;

FIG. 12 is a forwarding table of node 1 after receiving a forwarding table configuration command packet and successfully completing configuration in yet another multi-node system of the node address configuration method for a multi-node system of the present invention;

FIG. 13 is a forwarding table of node 4 after receiving a forwarding table configuration command packet and successfully completing configuration in yet another multi-node system of the node address configuration method for a multi-node system of the present invention;

FIG. 14 is a forwarding table configuration status packet returned after node 4 in an unconfigured state receives a forwarding table configuration command packet and successfully completes configuration in yet another multi-node system of the node address configuration method for a multi-node system of the present invention;

FIG. 15 is a structural block diagram of a further multi-node system of the node address configuration method for a multi-node system of the present invention.

### DETAILED DESCRIPTION OF EMBODIMENTS

The technical solutions in the embodiments of the present invention will be clearly and completely described below with reference to the accompanying drawings. It should be understood that the described embodiments are only a part of the embodiments of the present invention, not all of them. Based on the embodiments of the present invention, all other embodiments obtained by those skilled in the art without creative work shall fall within the protection scope of the present invention.

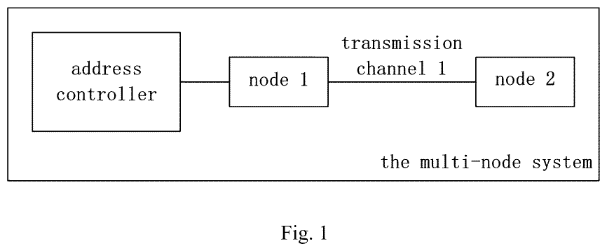

As shown in FIG. 1, in an application embodiment of the present invention, as a node address configuration method for a multi-node system of the present invention, the multi-node system comprises an address controller, node 1, and node 2.

The address controller in the multi-node system may be connected to one or more nodes; in this embodiment, the address controller is connected to node 1.

Each node in the multi-node system may be connected to one or more transmission channels and linked to one or more other nodes through the transmission channels; in this embodiment, node 1 is connected to node 2 through transmission channel 1, and node 2 is connected to node 1 through transmission channel 1.

The transmission channels in the multi-node system have transmission channel numbers; in this embodiment, the number of transmission channel 1 is 1.

The nodes in the multi-node system comprise address identifiers for identifying the addresses of the nodes. The state of the node comprises an unconfigured state and a configured state; in this embodiment, when the address controller has not configured the address identifier of the node, the node is in the unconfigured state; when the address controller completes the configuration of the address identifier of the node, the node is in the configured state. The address identifier of the node in the configured state may be the same as or different from the default address of the node. In other embodiments, when the address identifier of the node is the default address of the node, the node is in the unconfigured state; when the address identifier of the node is configured to be different from the default address of the node, the node is in the configured state, and the address identifier of the node in the configured state is different from the default address of the node. The default addresses of different nodes in the multi-node system may be the same or different; in this embodiment, node 1 and node 2 have the same default address, both of which are 0.

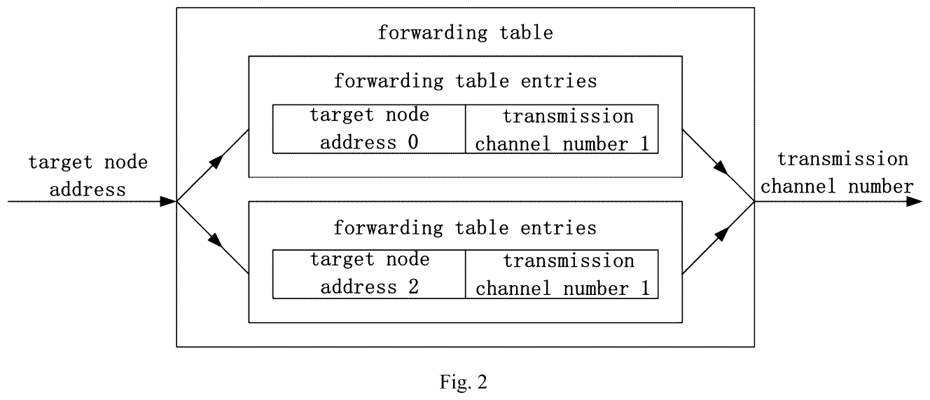

The nodes in the multi-node system may optionally include a forwarding table, where the input of the forwarding table is a target node address and the output is a transmission channel number. The forwarding table may include one or more forwarding table entries, and each forwarding table entry comprises a pair of target node address and transmission channel number. The forwarding table searches for a matching forwarding table entry according to the input target node address and outputs the transmission channel number in the entry. In this embodiment, node 1 comprises a forwarding table, and node 2 does not comprise a forwarding table or has no entries in the forwarding table. When node 1 is in the unconfigured state, the forwarding table of node 1 is as shown in FIG. 2, which comprises 2 forwarding table entries.

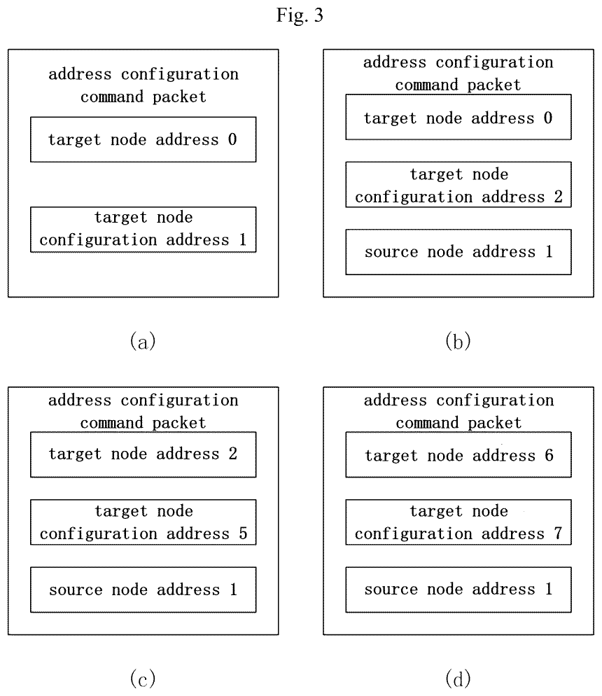

The address controller in the multi-node system sends an address configuration command packet to the nodes connected to it. The address configuration command packet comprises a target node address and a target node configuration address, and may optionally include a source node address, where the source node address is the address identifier of the node connected to the address controller. FIG. 3 shows 4 address configuration command packets sent by the address controller in this embodiment.

After receiving the address configuration command packet, the node in the multi-node system parses it: when the node is in the unconfigured state, if the target node address in the address configuration command packet is equal to the address identifier of the node, the node configures its address identifier as the target node configuration address in the address configuration command packet; when the node is in the configured state, if the target node address is not equal to the address identifier of the node and the node includes a forwarding table, the node queries the forwarding table using the target node address and sends the address configuration command packet to the connected node through the transmission channel indicated by the forwarding table. The method of sending the address configuration command packet to the connected node through the transmission channel indicated by the forwarding table is: if the forwarding table outputs a valid transmission channel number, the address configuration status packet is sent to the connected node through the transmission channel corresponding to the transmission channel number.

In this embodiment, when node 1 is in the unconfigured state, its address identifier is the default address 0. The address controller sends the address configuration command packet shown in FIG. 3(a). After receiving the address configuration command packet shown in FIG. 3(a), node 1 parses it. Since the target node address 0 in the address configuration command packet shown in FIG. 3(a) is equal to the address identifier 0 of node 1, node 1 configures its address identifier as the target node configuration address 1 in the address configuration command packet shown in FIG. 3(a).

Then, the address controller sends the address configuration command packet shown in FIG. 3(b). After receiving the address configuration command packet shown in FIG. 3(b), node 1 parses it. After node 1 configures its address identifier as 1, node 1 is in the configured state. Since the target node address 0 in the address configuration command packet shown in FIG. 3(b) is not equal to the address identifier 1 of node 1, node 1 queries the forwarding table shown in FIG. 2 using the target node address 0. The forwarding table outputs a valid transmission channel number 1, and node 1 sends the address configuration command packet shown in FIG. 3(b) to the connected node 2 through the transmission channel 1 corresponding to number 1. At this time, node 2 is in the unconfigured state, and its address identifier is the default address 0. After receiving the address configuration command packet shown in FIG. 3(b), node 2 parses it. Since the target node address 0 in the address configuration command packet shown in FIG. 3(b) is equal to the address identifier 0 of node 2, node 2 configures its address identifier as the target node configuration address 2 in the address configuration command packet shown in FIG. 3(b).

In this embodiment, the address controller completes the address configuration of node 1 and node 2. After configuration, the address identifier of node 1 is 1, and the address identifier of node 2 is 2.

In the subsequent data transmission process, if the target node address of the data packet is 1, node 1 receives the data packet; if the target node address of the data packet is 2, after node 1 receives the data packet, it queries the forwarding table shown in FIG. 2 through the target node address 2 to obtain the transmission channel number 1, and node 1 sends the data packet to transmission channel 1, and node 2 receives the data packet through transmission channel 1.

In this embodiment, in the configured state, if the target node address in the received address configuration command packet is equal to the address identifier of the node, the node configures its address identifier as the target node configuration address in the address configuration command packet. For example, after node 2 receives the address configuration command packet shown in FIG. 3(b), it configures its address identifier as 2,and node 2 is in the configured state. Then node 2 receives the address configuration command packet shown in FIG. 3(c) again. Since the target node address 2 in the address configuration command packet shown in FIG. 3(c) is equal to the address identifier 2 of node 2, node 2 configures its address identifier as the target node configuration address 5 in the address configuration command packet shown in FIG. 3(c). In other embodiments, in the configured state, if the target node address in the received address configuration command packet is equal to the address identifier of the node, the node may also choose not to change the address identifier.

In this embodiment, node 1 and node 2 are respectively integrated into a single integrated circuit chip, and node 1 may also be integrated into a single integrated circuit chip with the address controller.

After receiving the address configuration command packet, the node in the multi-node system may optionally return an address configuration status packet. The address configuration status packet comprises a target node address of the address configuration status packet and status information, where the target node address of the address configuration status packet is the source node address of the corresponding address configuration command packet. The node returns the address configuration status packet to the node connected to the address controller. After receiving the returned address configuration status packet, the node connected to the address controller may optionally return the status information in the address configuration status packet to the address controller connected to it.

In this embodiment, after node 1 receives the address configuration command packet shown in FIG. 3(a), since node 1 is the node connected to the address controller, it does not need to send the address configuration status packet, but may optionally send the status information of node 1 to the address controller.

The method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node forwards the address configuration status packet to the transmission channel through which the node received the address configuration command packet corresponding to the address configuration status packet.

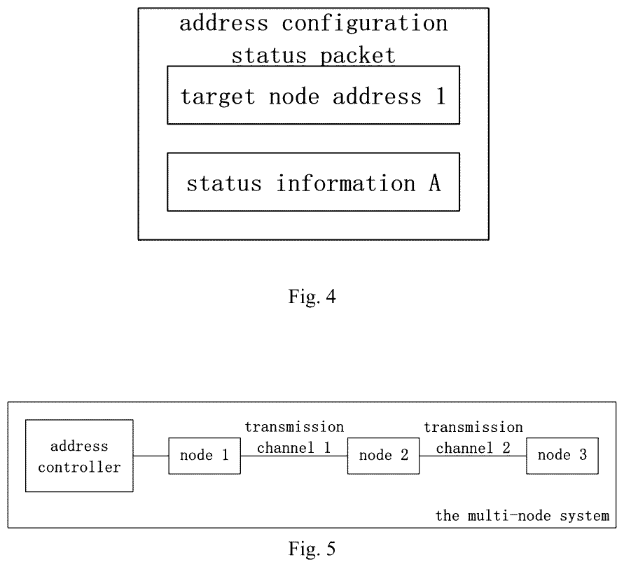

In this embodiment, after node 2 receives the address configuration command packet shown in FIG. 3(b), it returns the address configuration status packet shown in FIG. 4. The target node address of the address configuration status packet is the source node address 1 of the corresponding address configuration command packet shown in FIG. 3(b), so node 2 should return the address configuration status packet to node 1 connected to the address controller. Node 2 receives the address configuration command packet shown in FIG. 3(b) through transmission channel 1, so node 2 sends the address configuration status packet shown in FIG. 4 to node 1 through transmission channel 1. After receiving the address configuration status packet shown in FIG. 4, node 1 may optionally send the status information A therein to the address controller.

The status information in the address configuration status packet may be set to different values according to different situations. In this embodiment, 6 types of status information values may be set: (1) In the unconfigured state, if the target node address in the address configuration command packet is equal to the address identifier of the node and the node successfully configures its address identifier as the target node configuration address in the address configuration command packet, the node returns the address configuration status packet with the status information being status information A; (2) In the unconfigured state, if the target node address in the address configuration command packet is equal to the address identifier of the node and the node fails to configure its address identifier as the target node configuration address in the address configuration command packet, the node returns the address configuration status packet with the status information being status information B; (3) In the unconfigured state, if the target node address in the address configuration command packet is not equal to the address identifier of the node, the node returns the address configuration status packet with the status information being status information C; (4) In the configured state, if the target node address in the address configuration command packet is equal to the address identifier of the node and the node successfully configures its address identifier as the target node configuration address in the address configuration command packet, the node returns the address configuration status packet with the status information being status information D; (5) In the configured state, if the target node address in the address configuration command packet is equal to the address identifier of the node and the node fails to configure its address identifier as the target node configuration address in the address configuration command packet, the node returns the address configuration status packet with the status information being status information E; (6) In the configured state, if the target node address in the address configuration command packet is not equal to the address identifier of the node and the transmission channel number returned by the node querying the forwarding table using the target node address is invalid, the node returns the address configuration status packet with the status information being status information F. In other embodiments, the types of status information may be increased or decreased, the meanings of the status information values may be changed, or the address configuration status packet may be chosen not to be sent.

In this embodiment, node 2 is in the unconfigured state (address identifier is 0) when receiving the address configuration command packet shown in FIG. 3(b). The target node address 0 in the address configuration command packet shown in FIG. 3(b) is equal to the address identifier 0 of node 2, and node 2 successfully configures its address identifier as the target node configuration address 2 in the address configuration command packet shown in FIG. 3(b), which conforms to the case of the above-mentioned status information value (1). Therefore, the status information in the address configuration status packet shown in FIG. 4 returned by node 2 is status information A.

If node 2 is in the unconfigured state (address identifier is 0) when receiving the address configuration command packet shown in FIG. 3(b), the target node address 0 in the address configuration command packet shown in FIG. 3(b) is equal to the address identifier 0 of node 2, and node 2 fails to configure its address identifier as the target node configuration address 2 in the address configuration command packet shown in FIG. 3(b), which conforms to the case of the above-mentioned status information value (2). At this time, the status information in the address configuration status packet returned by node 2 is status information B.

If node 2 is in the unconfigured state (address identifier is 0) when receiving the address configuration command packet shown in FIG. 3(c), the target node address 2 in the address configuration command packet shown in FIG. 3(c) is not equal to the address identifier 0 of node 2, which conforms to the case of the above-mentioned status information value (3). At this time, the status information in the address configuration status packet returned by node 2 is status information C.

If node 2 is in the configured state (address identifier is 2) when receiving the address configuration command packet shown in FIG. 3(c), the target node address 2 in the address configuration command packet shown in FIG. 3(c) is equal to the address identifier 2 of node 2, and node 2 successfully configures its address identifier as the target node configuration address 5 in the address configuration command packet shown in FIG. 3(c), which conforms to the case of the above-mentioned status information value (4). At this time, the status information in the address configuration status packet returned by node 2 is status information D.

If node 2 is in the configured state (address identifier is 2) when receiving the address configuration command packet shown in FIG. 3(c), the target node address 2 in the address configuration command packet shown in FIG. 3(c) is equal to the address identifier 2 of node 2, and node 2 fails to configure its address identifier as the target node configuration address 5 in the address configuration command packet shown in FIG. 3(c), which conforms to the case of the above-mentioned status information value (5). At this time, the status information in the address configuration status packet returned by node 2 is status information E.

If node 2 is in the configured state (address identifier is 2) when receiving the address configuration command packet shown in FIG. 3(d), the target node address 6 in the address configuration command packet shown in FIG. 3(d) is not equal to the address identifier 2 of node 2, and the transmission channel number returned by node 2 querying the forwarding table using the target node address 6 is invalid, which conforms to the case of the above-mentioned status information value (6). At this time, the status information in the address configuration status packet returned by node 2 is status information F.

In the multi-node system, the node connected to the address controller may optionally include a timeout timer. When the address configuration status packet is not returned to the node before the timeout, the node stops waiting for the address configuration status packet and may optionally return timeout status information to the address controller connected to it.

In this embodiment, node 1 comprises a timeout timer. After node 1 sends the address configuration command packet shown in FIG. 3(b), it starts timing. If node 2 does not return the address configuration status packet shown in FIG. 4 in a timely manner after receiving the address configuration command packet shown in FIG. 3(b), and node 1 still does not receive the address configuration status packet returned by node 2 after the timeout timer reaches the preset value, node 1 stops waiting for the address configuration status packet and may optionally return timeout status information to the address controller. In other embodiments, the node connected to the address controller may not include a timeout timer, or may include a timeout timer but choose not to return timeout status information to the address controller if the address configuration status packet is not received after the timeout.

As shown in FIG. 5, in another application embodiment of the present invention, as a node address configuration method for a multi-node system of the present invention, the multi-node system comprises an address controller, node 1, node 2, and node 3.

In this embodiment, the address controller is connected to node 1. Node 1 is connected to node 2 through transmission channel 1. Node 2 is connected to node 1 through transmission channel 1 and to node 3 through transmission channel 2. Node 3 is connected to node 2 through transmission channel 2. The numbers of transmission channel 1 and transmission channel 2 are 1 and 2, respectively. Node 1, node 2, and node 3 have the same default address, all of which are 0. In the unconfigured state, node 1, node 2, and node 3 do not include a forwarding table or have no entries in the forwarding table.

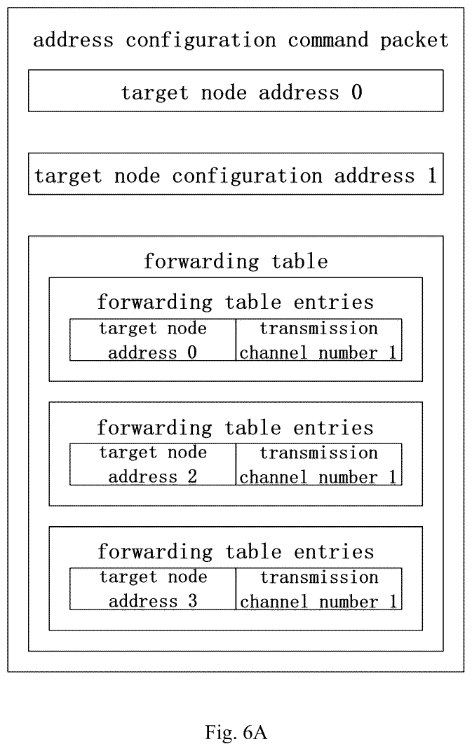

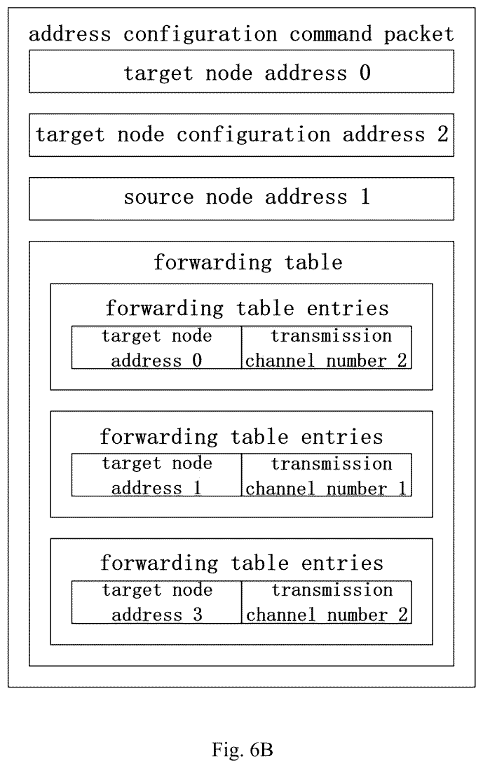

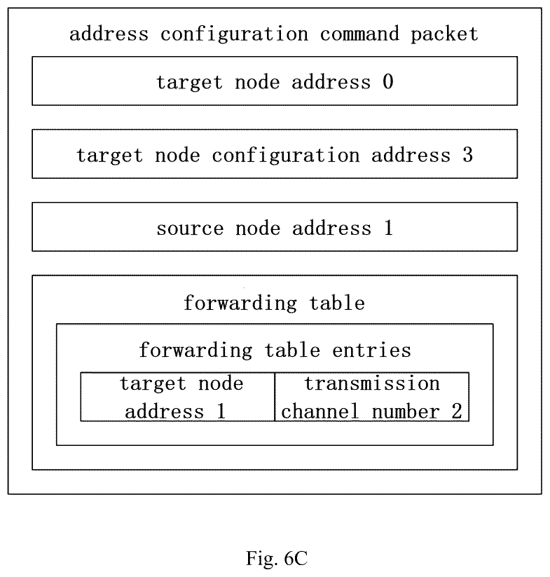

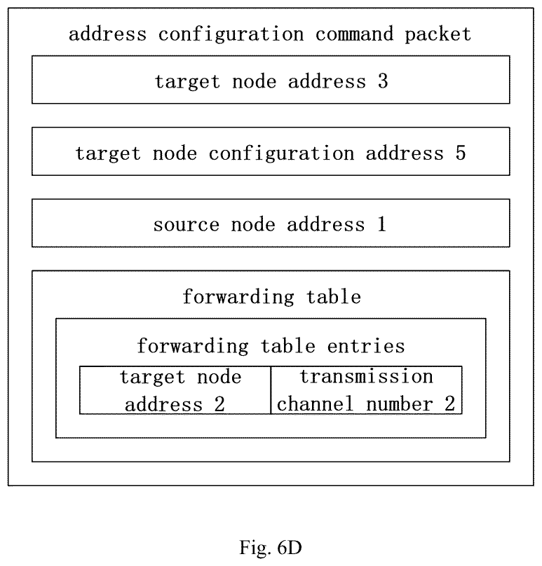

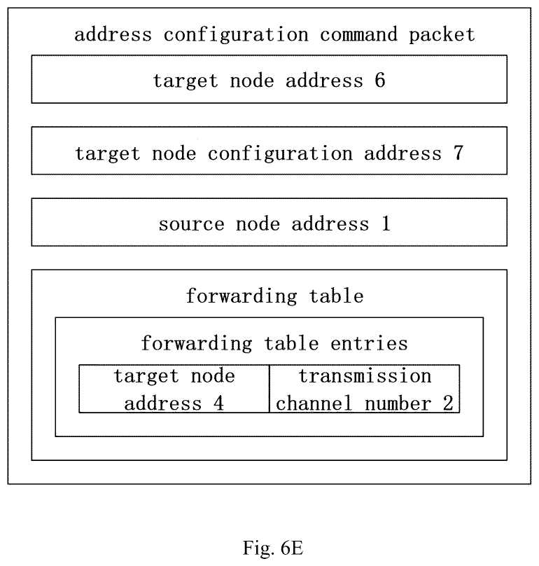

In this embodiment, the address controller sends an address configuration command packet to node 1. The address configuration command packet not only includes a target node address and a target node configuration address, but also may optionally include a source node address and forwarding table entry configuration information. FIG. 6A to FIG. 6E show 5 address configuration command packets sent by the address controller in this embodiment.

After receiving the address configuration command packet, the node in the multi-node system parses it: when the node is in the unconfigured state, if the target node address in the address configuration command packet is equal to the address identifier of the node, the node configures its address identifier as the target node configuration address in the address configuration command packet and configures the corresponding forwarding table entry according to the included forwarding table entry configuration information; when the node is in the configured state, if the target node address is not equal to the address identifier of the node and the node includes a forwarding table, the node queries the forwarding table using the target node address and sends the address configuration command packet to the connected node through the transmission channel indicated by the forwarding table. The method of sending the address configuration command packet to the connected node through the transmission channel indicated by the forwarding table is: if the forwarding table outputs a valid transmission channel number, the address configuration status packet is sent to the connected node through the transmission channel corresponding to the transmission channel number.

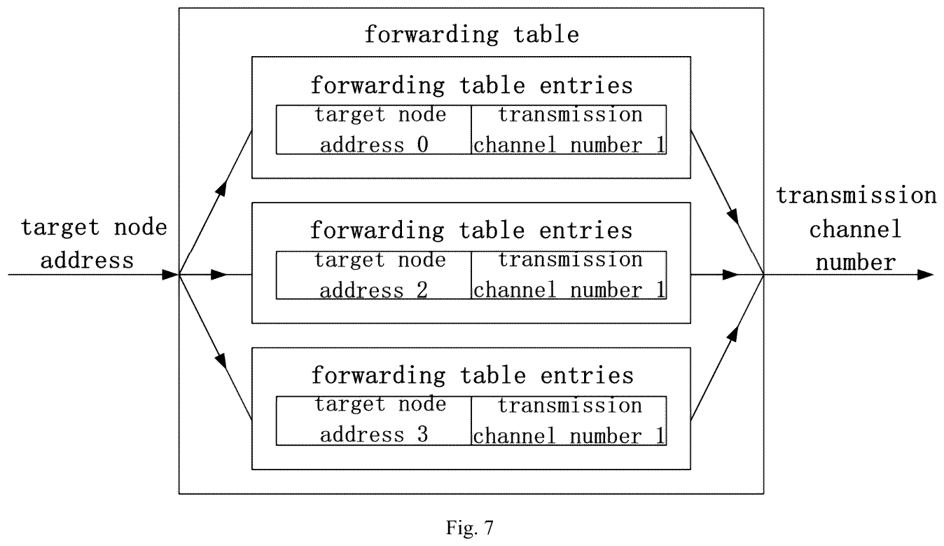

In this embodiment, when node 1 is in the unconfigured state, its address identifier is the default address 0. The address controller sends the address configuration command packet shown in FIG. 6A. After receiving the address configuration command packet shown in FIG. 6A, node 1 parses it. Since the target node address 0 in the address configuration command packet shown in FIG. 6A is equal to the address identifier 0 of node 1, node 1 configures its address identifier as the target node configuration address 1 in the address configuration command packet shown in FIG. 6A, and configures the corresponding forwarding table entry of node 1 according to the forwarding table entry configuration information included in the address configuration command packet shown in FIG. 6A. After configuration, the forwarding table of node 1 is as shown in FIG. 7, which comprises 3 forwarding table entries.

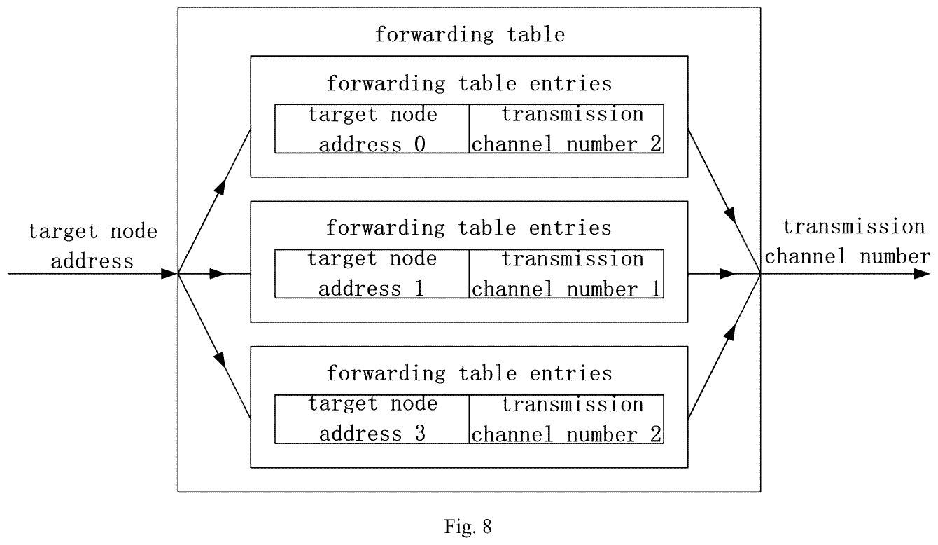

Then, the address controller sends the address configuration command packet shown in FIG. 6B. After receiving the address configuration command packet shown in FIG. 6B, node 1 parses it. After node 1 configures its address identifier as 1, node 1 is in the configured state. Since the target node address 0 in the address configuration command packet shown in FIG. 6B is not equal to the address identifier 1 of node 1, node 1 queries the forwarding table shown in FIG. 7 using the target node address 0. The forwarding table outputs a valid transmission channel number 1, and node 1 sends the address configuration command packet shown in FIG. 6B to the connected node 2 through the transmission channel 1 corresponding to number 1. At this time, node 2 is in the unconfigured state, and its address identifier is the default address 0. After receiving the address configuration command packet shown in FIG. 6B, node 2 parses it. Since the target node address 0 in the address configuration command packet shown in FIG. 6B is equal to the address identifier 0 of node 2, node 2 configures its address identifier as the target node configuration address 2 in the address configuration command packet shown in FIG. 6B, and configures the corresponding forwarding table entry of node 2 according to the forwarding table entry configuration information included in the address configuration command packet shown in FIG. 6B. After configuration, the forwarding table of node 2 is as shown in FIG. 8, which comprises 3 forwarding table entries.

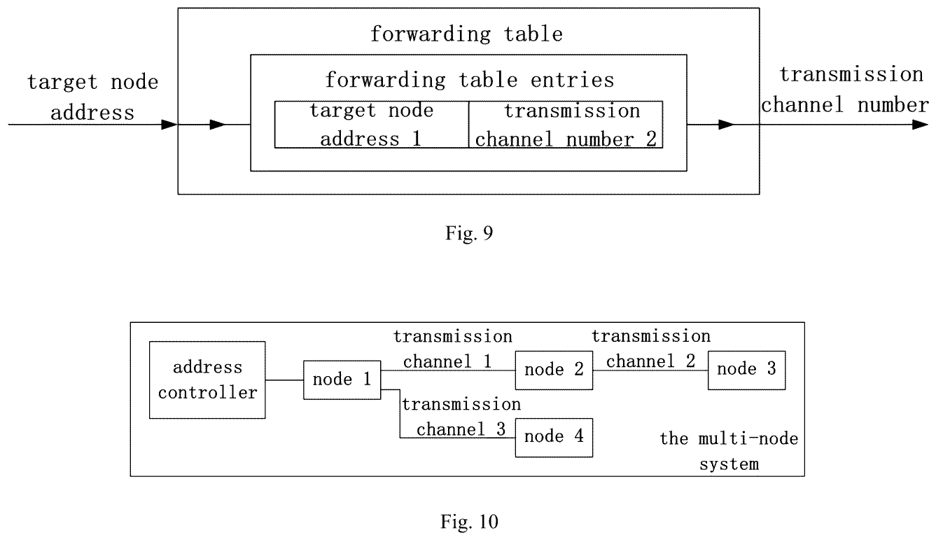

Then, the address controller sends the address configuration command packet shown in FIG. 6C. After receiving the address configuration command packet shown in FIG. 6C, node 1 parses it. After node 1 configures its address identifier as 1, node 1 is in the configured state. Since the target node address 0 in the address configuration command packet shown in FIG. 6C is not equal to the address identifier 1 of node 1, node 1 queries the forwarding table shown in FIG. 7 using the target node address 0. The forwarding table outputs a valid transmission channel number 1, and node 1 sends the address configuration command packet shown in FIG. 6C to the connected node 2 through the transmission channel 1 corresponding to number 1. After receiving the address configuration command packet shown in FIG. 6C, node 2 parses it. After node 2 configures its address identifier as 2, node 2 is in the configured state. Since the target node address 0 in the address configuration command packet shown in FIG. 6C is not equal to the address identifier 2 of node 2, node 2 queries the forwarding table shown in FIG. 8 using the target node address 0. The forwarding table outputs a valid transmission channel number 2, and node 2 sends the address configuration command packet shown in FIG. 6C to the connected node 3 through the transmission channel 2 corresponding to number 2. At this time, node 3 is in the unconfigured state, and its address identifier is the default address 0. After receiving the address configuration command packet shown in FIG. 6C, node 3 parses it. Since the target node address 0 in the address configuration command packet shown in FIG. 6C is equal to the address identifier 0 of node 3, node 3 configures its address identifier as the target node configuration address 3 in the address configuration command packet shown in FIG. 6C, and configures the corresponding forwarding table entry of node 3 according to the forwarding table entry configuration information included in the address configuration command packet shown in FIG. 6C. After configuration, the forwarding table of node 3 is as shown in FIG. 9, which comprises 1 forwarding table entry.

In this embodiment, the address controller completes the address configuration of node 1, node 2, and node 3. After configuration, the address identifier of node 1 is 1, the address identifier of node 2 is 2, the address identifier of node 3 is 3, and the forwarding tables of node 1, node 2, and node 3 are as shown in FIG. 7, FIG. 8, and FIG. 9, respectively.

In the subsequent data transmission process, if the target node address of the data packet is 1, node 1 receives the data packet; if the target node address of the data packet is 2, after node 1 receives the data packet, it queries the forwarding table shown in FIG. 7 through the target node address 2 to obtain the transmission channel number 1, and node 1 sends the data packet to transmission channel 1, and node 2 receives the data packet through transmission channel 1; if the target node address of the data packet is 3, after node 1 receives the data packet, it queries the forwarding table shown in FIG. 7 through the target node address 3 to obtain the transmission channel number 1, and node 1 sends the data packet to transmission channel 1. After node 2 receives the data packet, it queries the forwarding table shown in FIG. 8 through the target node address 3 to obtain the transmission channel number 2, and node 2 sends the data packet to transmission channel 2, and node 3 receives the data packet through transmission channel 2.

In this embodiment, in the configured state, if the target node address in the received address configuration command packet is equal to the address identifier of the node, the node configures its address identifier as the target node configuration address in the address configuration command packet and configures the corresponding forwarding table entry according to the included forwarding table entry configuration information. For example, after node 3 receives the address configuration command packet shown in FIG. 6C, it configures its address identifier as 3, and node 3 is in the configured state. Then node 3 receives the address configuration command packet shown in FIG. 6D again. Since the target node address 3 in the address configuration command packet shown in FIG. 6D is equal to the address identifier 3 of node 3, node 3 configures its address identifier as the target node configuration address 5 in the address configuration command packet shown in FIG. 6D and configures the corresponding forwarding table entry according to the included forwarding table entry configuration information. In other embodiments, in the configured state, if the target node address in the received address configuration command packet is equal to the address identifier of the node, the node may also choose to configure its address identifier as the target node configuration address in the address configuration command packet but not change the forwarding table, or configure the corresponding forwarding table entry according to the forwarding table entry configuration information included in the address configuration command packet but not change the address identifier, or neither change the address identifier nor the forwarding table.

In this embodiment, node 1, node 2, and node 3 are respectively integrated into a single integrated circuit chip, and node 1 may also be integrated into a single integrated circuit chip with the address controller.

After receiving the address configuration command packet, the node in the multi-node system may optionally return an address configuration status packet. The address configuration status packet includes a target node address of the address configuration status packet and status information, where the target node address of the address configuration status packet is the source node address of the corresponding address configuration command packet. The node returns the address configuration status packet to the node connected to the address controller. After receiving the returned address configuration status packet, the node connected to the address controller may optionally return the status information in the address configuration status packet to the address controller connected to it.

In this embodiment, after node 1 receives the address configuration command packet shown in FIG. 6A, since node 1 is the node connected to the address controller, it does not need to send the address configuration status packet, but may optionally send the status information of node 1 to the address controller.

Different from the embodiment shown in FIG. 1, in this embodiment, the method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node queries the forwarding table using the target node address in the address configuration status packet and sends the address configuration status packet to the connected node through the transmission channel indicated by the forwarding table.

In this embodiment, after node 2 receives the address configuration command packet shown in FIG. 6B, it returns the address configuration status packet shown in FIG. 4. The target node address of the address configuration status packet is the source node address 1 of the corresponding address configuration command packet shown in FIG. 6B, so node 2 should return the address configuration status packet to node 1 connected to the address controller. Node 2 queries the forwarding table shown in FIG. 8 using the target node address 1 in the address configuration status packet shown in FIG. 4, and sends the address configuration status packet shown in FIG. 4 to node 1 through the transmission channel 1 indicated by the forwarding table shown in FIG. 8. After receiving the address configuration status packet shown in FIG. 4, node 1 may optionally send the status information A therein to the address controller.

After node 3 receives the address configuration command packet shown in FIG. 6C, it also returns the address configuration status packet shown in FIG. 4. The target node address of the address configuration status packet is the source node address 1 of the corresponding address configuration command packet shown in FIG. 6C, so node 3 should return the address configuration status packet to node 1 connected to the address controller. Node 3 queries the forwarding table shown in FIG. 9 using the target node address 1 in the address configuration status packet shown in FIG. 4, and sends the address configuration status packet shown in FIG. 4 to node 2 through the transmission channel 2 indicated by the forwarding table shown in FIG. 9. Node 2 queries the forwarding table shown in FIG. 8 using the target node address 1 in the address configuration status packet shown in FIG. 4, and sends the address configuration status packet shown in FIG. 4 to node 1 through the transmission channel 1 indicated by the forwarding table shown in FIG. 8. After receiving the address configuration status packet shown in FIG. 4, node 1 may optionally send the status information A therein to the address controller.

The status information in the address configuration status packet may be set to different values according to different situations. In this embodiment, 6 types of status information values may be set: (1) In the unconfigured state, if the target node address in the address configuration command packet is equal to the address identifier of the node and the node successfully configures its address identifier as the target node configuration address in the address configuration command packet and configures the corresponding forwarding table entry according to the included forwarding table entry configuration information, the node returns the address configuration status packet with the status information being status information A; (2) In the unconfigured state, if the target node address in the address configuration command packet is equal to the address identifier of the node and the node fails to configure its address identifier as the target node configuration address in the address configuration command packet and configure the corresponding forwarding table entry according to the included forwarding table entry configuration information, the node returns the address configuration status packet with the status information being status information B; (3) In the unconfigured state, if the target node address in the address configuration command packet is not equal to the address identifier of the node, the node returns the address configuration status packet with the status information being status information C; (4) In the configured state, if the target node address in the address configuration command packet is equal to the address identifier of the node and the node successfully configures its address identifier as the target node configuration address in the address configuration command packet and configures the corresponding forwarding table entry according to the included forwarding table entry configuration information, the node returns the address configuration status packet with the status information being status information D; (5) In the configured state, if the target node address in the address configuration command packet is equal to the address identifier of the node and the node fails to configure its address identifier as the target node configuration address in the address configuration command packet and configure the corresponding forwarding table entry according to the included forwarding table entry configuration information, the node returns the address configuration status packet with the status information being status information E; (6) In the configured state, if the target node address in the address configuration command packet is not equal to the address identifier of the node and the transmission channel number returned by the node querying the forwarding table using the target node address is invalid, the node returns the address configuration status packet with the status information being status information F. In other embodiments, the types of status information may be increased or decreased, the meanings of the status information values may be changed, or the address configuration status packet may be chosen not to be sent.

In this embodiment, node 2 is in the unconfigured state (address identifier is 0) when receiving the address configuration command packet shown in FIG. 6B. The target node address 0 in the address configuration command packet shown in FIG. 6B is equal to the address identifier 0 of node 2, and node 2 successfully configures its address identifier as the target node configuration address 2 in the address configuration command packet shown in FIG. 6B and configures the corresponding forwarding table entry of the forwarding table shown in FIG. 8 according to the included forwarding table entry configuration information, which conforms to the case of the above-mentioned status information value (1). Therefore, the status information in the address configuration status packet shown in FIG. 4 returned by node 2 is status information A.

Node 3 is in the unconfigured state (address identifier is 0) when receiving the address configuration command packet shown in FIG. 6C. The target node address 0 in the address configuration command packet shown in FIG. 6C is equal to the address identifier 0 of node 3, and node 3 successfully configures its address identifier as the target node configuration address 3 in the address configuration command packet shown in FIG. 6C and configures the corresponding forwarding table entry of the forwarding table shown in FIG. 9 according to the included forwarding table entry configuration information, which conforms to the case of the above-mentioned status information value (1). Therefore, the status information in the address configuration status packet shown in FIG. 4 returned by node 3 is status information A.

If node 3 is in the unconfigured state (address identifier is 0) when receiving the address configuration command packet shown in FIG. 6C, the target node address 0 in the address configuration command packet shown in FIG. 6C is equal to the address identifier 0 of node 3, and node 3 fails to configure its address identifier as the target node configuration address 3 in the address configuration command packet shown in FIG. 6C and configure the corresponding forwarding table entry according to the included forwarding table entry configuration information, which conforms to the case of the above-mentioned status information value (2). At this time, the status information in the address configuration status packet returned by node 3 is status information B.

If node 3 is in the unconfigured state (address identifier is 0) when receiving the address configuration command packet shown in FIG. 6D, the target node address 3 in the address configuration command packet shown in FIG. 6D is not equal to the address identifier 0 of node 3, which conforms to the case of the above-mentioned status information value (3). At this time, the status information in the address configuration status packet returned by node 3 is status information C.

If node 3 is in the configured state (address identifier is 3) when receiving the address configuration command packet shown in FIG. 6D, the target node address 3 in the address configuration command packet shown in FIG. 6D is equal to the address identifier 3 of node 3, and node 3 successfully configures its address identifier as the target node configuration address 5 in the address configuration command packet shown in FIG. 6D and configures the corresponding forwarding table entry according to the included forwarding table entry configuration information, which conforms to the case of the above-mentioned status information value (4). At this time, the status information in the address configuration status packet returned by node 3 is status information D.

If Node 3, in the configured state (with an address identifier of 3), receives the address configuration command packet shown in FIG. 6D, where the target node address 3 in the address configuration command packet (FIG. 6D) is equal to the address identifier 3 of Node 3, and Node 3 fails to configure its address identifier as the target node configuration address 5 in the address configuration command packet (FIG. 6D) and to configure the corresponding forwarding table entry based on the included forwarding table entry configuration information, this situation falls under the 5th type of status information value mentioned above. At this time, the status information in the address configuration status packet returned by Node 3 is Status Information E.

If Node 3, in the configured state (with an address identifier of 3), receives the address configuration command packet shown in FIG. 6E, where the target node address 6 in the address configuration command packet (FIG. 6E) is not equal to the address identifier 3 of Node 3, and the transmission channel number returned by Node 3 querying the forwarding table using the target node address 6 is invalid, this situation falls under the 6th type of status information value mentioned above. At this time, the status information in the address configuration status packet returned by Node 3 is Status Information F.

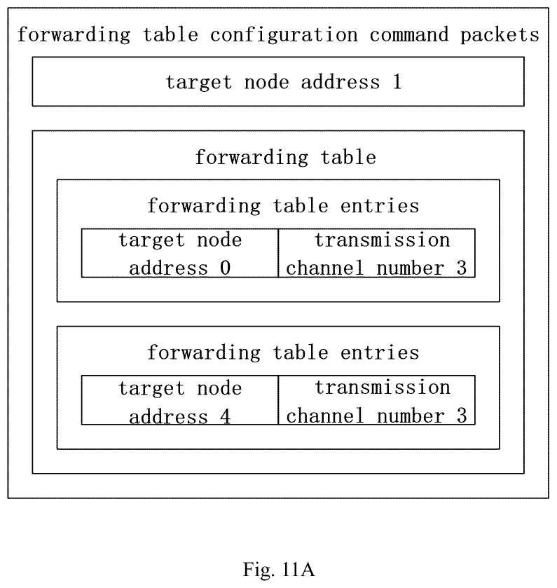

As shown in FIG. 10, in yet another application embodiment of the present invention, as a node address configuration method for a multi-node system of the present invention, the multi-node system comprises an address controller, Node 1, Node 2, Node 3, and Node 4.

In this embodiment, the address controller is connected to Node 1. Node 1 is connected to Node 2 via Transmission Channel 1 and to Node 4 via Transmission Channel 3. Node 2 is connected to Node 1 via Transmission Channel 1 and to Node 3 via Transmission Channel 2. Node 3 is connected to Node 2 via Transmission Channel 2. Node 4 is connected to Node 1 via Transmission Channel 3. The numbers of Transmission Channel 1, Transmission Channel 2, and Transmission Channel 3 are 1, 2, and 3 respectively. Node 1, Node 2, Node 3, and Node 4 have the same default node address, which is 0 for all. In the unconfigured state, Node 1, Node 2, Node 3, and Node 4 either do not include a forwarding table or have no entries in their forwarding tables.

The address controller in the multi-node system can not only send address configuration command packets to the nodes connected to it, but also send forwarding table configuration command packets. A forwarding table configuration command packet includes a target node address and one or more pieces of forwarding table entry configuration information, and may optionally include a source node address. The source node address is the address identifier of the node connected to the address controller.

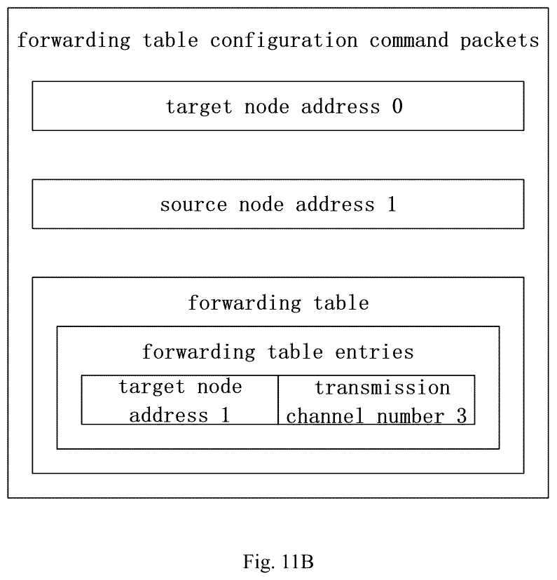

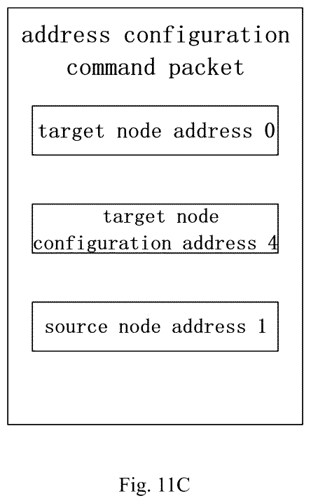

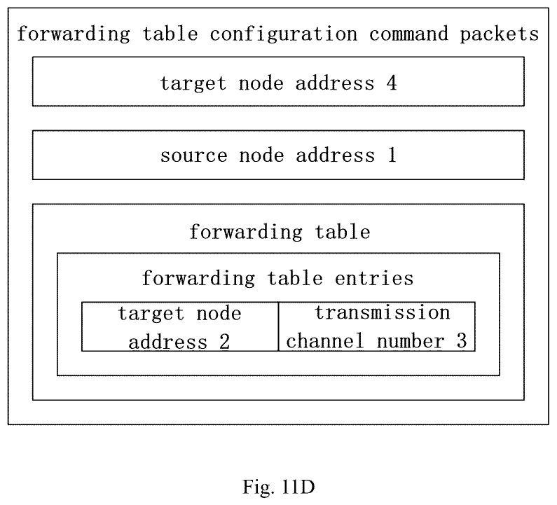

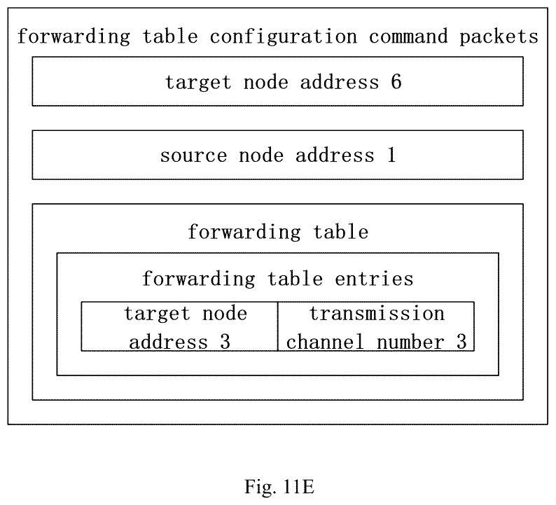

In this embodiment, the initial process of configuring the address identifiers and forwarding tables of Node 1, Node 2, and Node 3 is the same as that in the embodiment shown in FIG. 5. The address controller configures the address identifiers and forwarding tables of Node 1, Node 2, and Node 3 respectively by sending the 3 address configuration command packets shown in FIG. 6A to FIG. 6E. After configuration, the address identifier of Node 1 is 1, the address identifier of Node 2 is 2, the address identifier of Node 3 is 3, and the forwarding tables of Node 1, Node 2, and Node 3 are as shown in FIG. 7, FIG. 8, and FIG. 9 respectively. After completing the above process, the address controller continues to configure Node 1 and Node 4 by sending forwarding table configuration command packets and address configuration command packets. FIG. 11A to FIG. 11E shows 4 forwarding table configuration command packets and 1 address configuration command packet sent by the address controller in this embodiment.

After receiving a forwarding table configuration command packet, a node in the multi-node system parses it. If the node is in the unconfigured state and the target node address in the forwarding table configuration command packet is equal to the node's address identifier, the node configures the corresponding forwarding table entry based on the forwarding table entry configuration information. If the node is in the configured state and the target node address is not equal to the node's address identifier, the node queries the forwarding table using the target node address and sends the forwarding table configuration command packet to the connected node via the transmission channel indicated by the forwarding table. The method of sending the forwarding table configuration command packet to the connected node via the transmission channel indicated by the forwarding table is as follows: if the forwarding table outputs a valid transmission channel number, the forwarding table configuration command packet is sent to the connected node via the transmission channel corresponding to that transmission channel number.

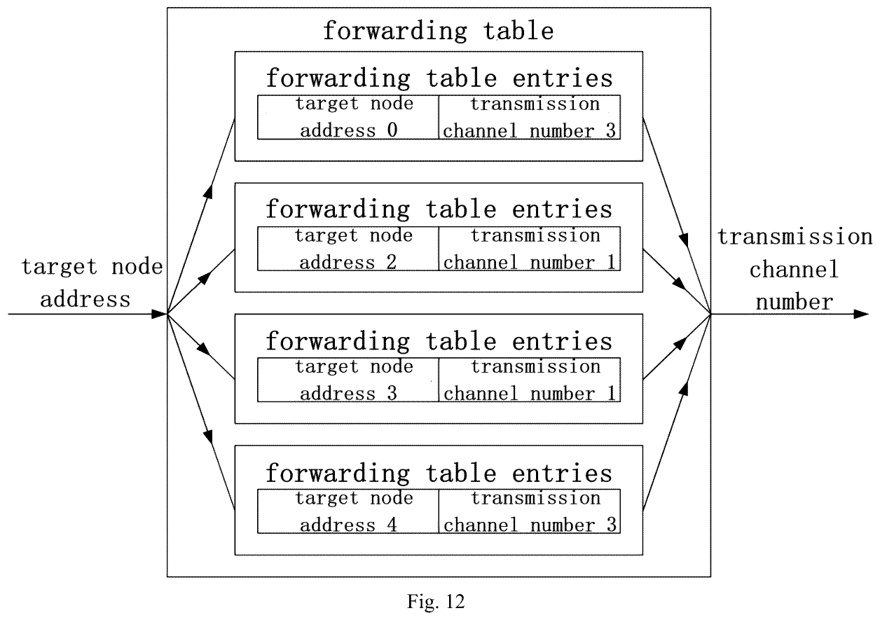

In this embodiment, when Node 1 has an address identifier of 1, its forwarding table is as shown in FIG. 7, and Node 1 is in the configured state, the address controller sends the forwarding table configuration command packet shown in FIG. 11A. After receiving the forwarding table configuration command packet (FIG. 11A), Node 1 parses it. Since the target node address 1 in the forwarding table configuration command packet (FIG. 11A) is equal to the address identifier 1 of Node 1, Node 1 configures the corresponding forwarding table entry of Node 1 based on the forwarding table entry configuration information included in the forwarding table configuration command packet (FIG. 11A). After configuration, the forwarding table of Node 1 is as shown in FIG. 12, which contains 4 forwarding table entries.

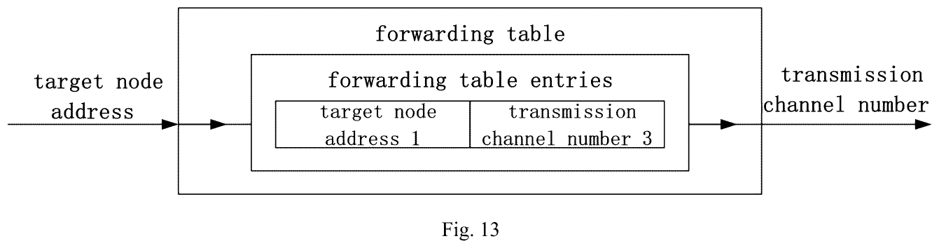

Next, the address controller sends the forwarding table configuration command packet shown in FIG. 11B. After receiving the forwarding table configuration command packet (FIG. 11B), Node 1 parses it. Node 1 is in the configured state, and since the target node address 0 in the forwarding table configuration command packet (FIG. 11B) is not equal to the address identifier 1 of Node 1, Node 1 queries the forwarding table shown in FIG. 12 using the target node address 0. The forwarding table outputs a valid transmission channel number 3, so Node 1 sends the forwarding table configuration command packet (FIG. 11B) to the connected Node 4 via Transmission Channel 3 corresponding to number 3. At this time, Node 4 is in the unconfigured state, with its address identifier being the default address 0. After receiving the forwarding table configuration command packet (FIG. 11B), Node 4 parses it. Since the target node address 0 in the forwarding table configuration command packet (FIG. 11B) is equal to the address identifier 0 of Node 4, Node 4 configures the corresponding forwarding table entry of Node 4 based on the forwarding table entry configuration information included in the forwarding table configuration command packet (FIG. 11B). After configuration, the forwarding table of Node 4 is as shown in FIG. 13, which contains 1 forwarding table entry.

Subsequently, the address controller sends the address configuration command packet shown in FIG. 11C. After receiving the address configuration command packet (FIG. 11C), Node 1 parses it. Node 1 is in the configured state, and since the target node address 0 in the address configuration command packet (FIG. 11C) is not equal to the address identifier 1 of Node 1, Node 1 queries the forwarding table shown in FIG. 12 using the target node address 0. The forwarding table outputs a valid transmission channel number 3, so Node 1 sends the address configuration command packet (FIG. 11C) to the connected Node 4 via Transmission Channel 3 corresponding to number 3. At this time, Node 4 is in the unconfigured state, with its address identifier being the default address 0. After receiving the address configuration command packet (FIG. 11C), Node 4 parses it. Since the target node address 0 in the address configuration command packet (FIG. 11C) is equal to the address identifier 0 of Node 4, Node 4 configures its address identifier as the target node configuration address 4 in the address configuration command packet (FIG. 11C).

In this embodiment, the address controller completes the address configuration of Node 1, Node 2, Node 3, and Node 4. After configuration, the address identifier of Node 1 is 1, the address identifier of Node 2 is 2, the address identifier of Node 3 is 3, the address identifier of Node 4 is 4, and the forwarding tables of Node 1, Node 2, Node 3, and Node 4 are as shown in FIG. 12, FIG. 8, FIG. 9, and FIG. 13 respectively.

In the subsequent data transmission process: If the target node address of a data packet is 1, Node 1 receives the data packet; If the target node address of the data packet is 2, after Node 1 receives the data packet, it queries the forwarding table (FIG. 12) using the target node address 2 to obtain transmission channel number 1, and Node 1 sends the data packet to Transmission Channel 1, which is then received by Node 2 via Transmission Channel 1; If the target node address of the data packet is 3, after Node 1 receives the data packet, it queries the forwarding table (FIG. 12) using the target node address 3 to obtain transmission channel number 1, and Node 1 sends the data packet to Transmission Channel 1. After Node 2 receives the data packet, it queries the forwarding table (FIG. 8) using the target node address 3 to obtain transmission channel number 2, and Node 2 sends the data packet to Transmission Channel 2, which is then received by Node 3 via Transmission Channel 2; If the target node address of the data packet is 4, after Node 1 receives the data packet, it queries the forwarding table (FIG. 12) using the target node address 4 to obtain transmission channel number 3, and Node 1 sends the data packet to Transmission Channel 3, which is then received by Node 4 via Transmission Channel 3.

In this embodiment, when a node is in the configured state, if the target node address in the received forwarding table configuration command packet is equal to the node's address identifier, the node configures the corresponding forwarding table entry based on the forwarding table entry configuration information included in the forwarding table configuration command packet. For example, after Node 4 receives the address configuration command packet (FIG. 11C), it configures its address identifier as 4 and enters the configured state. Subsequently, Node 4 receives the forwarding table configuration command packet (FIG. 11D). Since the target node address 4 in the forwarding table configuration command packet (FIG. 11D) is equal to the address identifier 4 of Node 4, Node 4 configures the corresponding forwarding table entry based on the forwarding table entry configuration information included in the forwarding table configuration command packet (FIG. 11D). In other embodiments, when a node is in the configured state, if the target node address in the received forwarding table configuration command packet is equal to the node's address identifier, the node may also choose not to modify the forwarding table.

In this embodiment, Node 1, Node 2, Node 3, and Node 4 are each integrated into a single integrated circuit chip. Alternatively, Node 1 may be integrated into a single integrated circuit chip together with the address controller.

After receiving a forwarding table configuration command packet, a node in the multi-node system may optionally return a forwarding table configuration status packet. The forwarding table configuration status packet comprises a target node address of the forwarding table configuration status packet and status information. The target node address of the forwarding table configuration status packet is the source node address of the corresponding forwarding table configuration command packet. The node returns the forwarding table configuration status packet to the node connected to the address controller. After receiving the returned forwarding table configuration status packet, the node connected to the address controller may optionally return the status information in the forwarding table configuration status packet to the address controller connected to it.

In this embodiment, after Node 1 receives the forwarding table configuration command packet (FIG. 11A), since Node 1 is the node connected to the address controller, it does not need to send a forwarding table configuration status packet, but may optionally send its own status information to the address controller.

One method for a node to return the forwarding table configuration status packet to the node connected to the address controller is as follows: A node on the return path of the forwarding table configuration status packet parses the packet. If the target node address in the forwarding table configuration status packet is equal to the node's address identifier, the node receives the packet. If the target node address in the forwarding table configuration status packet is not equal to the node's address identifier, the node forwards the forwarding table configuration status packet to the transmission channel through which it received the forwarding table configuration command packet corresponding to this status packet.

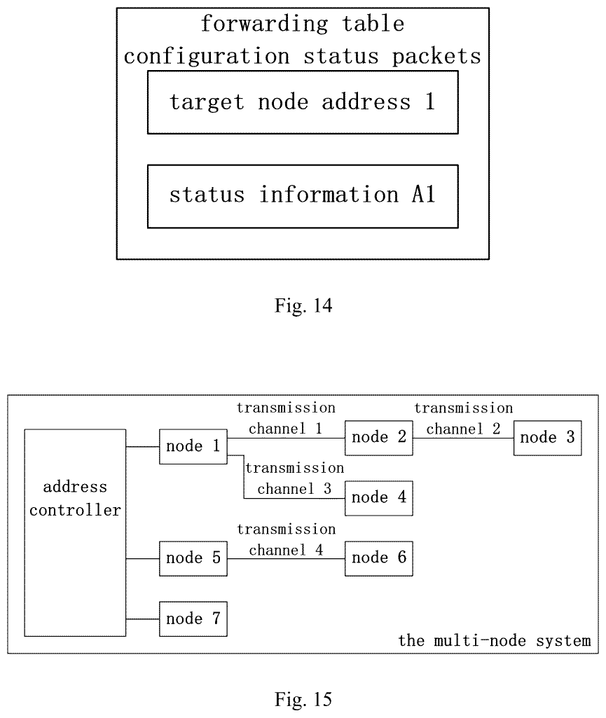

In this embodiment, after Node 4 receives the forwarding table configuration command packet (FIG. 11B), it returns the forwarding table configuration status packet shown in FIG. 14. The target node address of this forwarding table configuration status packet is the source node address 1 of the corresponding forwarding table configuration command packet (FIG. 11B), so Node 4 should return the forwarding table configuration status packet to Node 1 (the node connected to the address controller). Node 4 receives the forwarding table configuration command packet (FIG. 11B) via Transmission Channel 3, so it sends the forwarding table configuration status packet (FIG. 14) to Node 1 via Transmission Channel 1. After receiving the forwarding table configuration status packet (FIG. 14), Node 1 may optionally send the status information A1 contained therein to the address controller.

Another method for a node to return the forwarding table configuration status packet to the node connected to the address controller is as follows: A node on the return path of the forwarding table configuration status packet parses the packet. If the target node address in the forwarding table configuration status packet is equal to the node's address identifier, the node receives the packet. If the target node address in the forwarding table configuration status packet is not equal to the node's address identifier, the node queries the forwarding table using the target node address in the forwarding table configuration status packet and sends the packet to the connected node via the transmission channel indicated by the forwarding table.

In this embodiment, Node 4 may also return the forwarding table configuration status packet to Node 1 using the following method: After receiving the forwarding table configuration command packet (FIG. 11B), Node 4 returns the forwarding table configuration status packet shown in FIG. 14. The target node address of this status packet is the source node address 1 of the corresponding forwarding table configuration command packet (FIG. 11B), so Node 4 should return the status packet to Node 1 (connected to the address controller). Node 4 queries the forwarding table (FIG. 13) using the target node address 1 in the forwarding table configuration status packet (FIG. 14) and sends the status packet to Node 1 via Transmission Channel 3 indicated by the forwarding table (FIG. 13). After receiving the forwarding table configuration status packet (FIG. 14), Node 1 may optionally send the status information A1 contained therein to the address controller.

The status information in the forwarding table configuration status packet can be set to different values according to different scenarios. In this embodiment, 6 types of status information values can be set: (1) When a node is in the unconfigured state, the target node address in the forwarding table configuration command packet is equal to the node's address identifier, and the node successfully configures the corresponding forwarding table entry based on the forwarding table entry configuration information included in the command packet, the node returns a forwarding table configuration status packet with status information A1; (2) When a node is in the unconfigured state, the target node address in the forwarding table configuration command packet is equal to the node's address identifier, and the node fails to configure the corresponding forwarding table entry based on the forwarding table entry configuration information included in the command packet, the node returns a forwarding table configuration status packet with status information B1; (3) When a node is in the unconfigured state and the target node address in the forwarding table configuration command packet is not equal to the node's address identifier, the node returns a forwarding table configuration status packet with status information C1; (4) When a node is in the configured state, the target node address in the forwarding table configuration command packet is equal to the node's address identifier, and the node successfully configures the corresponding forwarding table entry based on the forwarding table entry configuration information included in the command packet, the node returns a forwarding table configuration status packet with status information D1; (5) When a node is in the configured state, the target node address in the forwarding table configuration command packet is equal to the node's address identifier, and the node fails to configure the corresponding forwarding table entry based on the forwarding table entry configuration information included in the command packet, the node returns a forwarding table configuration status packet with status information E1; (6) When a node is in the configured state, the target node address in the forwarding table configuration command packet is not equal to the node's address identifier, and the transmission channel number returned by the node querying the forwarding table using the target node address is invalid, the node returns a forwarding table configuration status packet with status information F1.

In other embodiments, the types of status information may be increased or decreased, the meanings of the status information values may be modified, or the option of not sending a forwarding table configuration status packet may be selected.

In this embodiment, Node 4, in the unconfigured state (with an address identifier of 0), receives the forwarding table configuration command packet (FIG. 11B). The target node address 0 in the command packet (FIG. 11B) is equal to the address identifier 0 of Node 4, and Node 4 successfully configures the corresponding entry in the forwarding table (FIG. 13) based on the forwarding table entry configuration information included in the command packet (FIG. 11B). This situation falls under the 1st type of status information value mentioned above, so the status information in the forwarding table configuration status packet (FIG. 14) returned by Node 4 is Status Information A1.

If Node 4, in the unconfigured state (with an address identifier of 0), receives the forwarding table configuration command packet (FIG. 11B), where the target node address 0 in the command packet (FIG. 11B) is equal to the address identifier 0 of Node 4, but Node 4 fails to configure the corresponding forwarding table entry based on the forwarding table entry configuration information included in the command packet (FIG. 11B), this situation falls under the 2nd type of status information value mentioned above. At this time, the status information in the forwarding table configuration status packet returned by Node 4 is Status Information B1.

If Node 4, in the unconfigured state (with an address identifier of 0), receives the forwarding table configuration command packet (FIG. 11D), where the target node address 4 in the command packet (FIG. 11D) is not equal to the address identifier 0 of Node 4, this situation falls under the 3rd type of status information value mentioned above. At this time, the status information in the forwarding table configuration status packet returned by Node 4 is Status Information C1.

If Node 4, in the configured state (with an address identifier of 4), receives the forwarding table configuration command packet (FIG. 11D), where the target node address 4 in the command packet (FIG. 11D) is equal to the address identifier 4 of Node 4, and Node 4 successfully configures the corresponding forwarding table entry based on the forwarding table entry configuration information included in the command packet (FIG. 11D), this situation falls under the 4th type of status information value mentioned above. At this time, the status information in the forwarding table configuration status packet returned by Node 4 is Status Information D1.

If Node 4, in the configured state (with an address identifier of 4), receives the forwarding table configuration command packet (FIG. 11D), where the target node address 4 in the command packet (FIG. 11D) is equal to the address identifier 4 of Node 4, but Node 4 fails to configure the corresponding forwarding table entry based on the forwarding table entry configuration information included in the command packet (FIG. 11D), this situation falls under the 5th type of status information value mentioned above. At this time, the status information in the forwarding table configuration status packet returned by Node 4 is Status Information E1.

If Node 4, in the configured state (with an address identifier of 4), receives the forwarding table configuration command packet (FIG. 11E), where the target node address 6 in the command packet (FIG. 11E) is not equal to the address identifier 4 of Node 4, and the transmission channel number returned by Node 4 querying the forwarding table using the target node address 6 is invalid, this situation falls under the 6th type of status information value mentioned above. At this time, the status information in the forwarding table configuration status packet returned by Node 4 is Status Information F1.

In the multi-node system, the node connected to the address controller may optionally include a timeout timer. If the forwarding table configuration status packet is not returned to this node before the timeout expires, the node stops waiting for the status packet and may optionally return timeout status information to the address controller connected to it.

In this embodiment, Node 1 includes a timeout timer. After Node 1 sends the forwarding table configuration command packet (FIG. 11B), it starts timing. If Node 4 does not return the forwarding table configuration status packet (FIG. 4) in a timely manner after receiving the command packet (FIG. 11B), and Node 1 still does not receive the status packet returned by Node 4 after the timeout timer reaches the preset value, Node 1 stops waiting for the forwarding table configuration status packet and may optionally return timeout status information to the address controller. In other embodiments, the node connected to the address controller may not include a timeout timer, or may include a timeout timer but choose not to return timeout status information to the address controller if the forwarding table configuration status packet is not received after the timeout.

In the embodiments shown in FIG. 1, FIG. 5, and FIG. 10, the address controller in the multi-node system is connected to one node. In other embodiments, the address controller in the multi-node system may also be connected to multiple nodes.

As shown in FIG. 15, in a further application embodiment of the present invention, as a node address configuration method for a multi-node system of the present invention, the address controller in the multi-node system is connected to Node 1, Node 5, and Node 7.

After receiving an address configuration command packet or a forwarding table configuration command packet: Node 2, Node 3, and Node 4 should return an address configuration status packet or a forwarding table configuration status packet to Node 1. After receiving the returned status packet, Node 1 may optionally return the status information contained therein to the address controller; Node 6 should return an address configuration status packet or a forwarding table configuration status packet to Node 5. After receiving the returned status packet, Node 5 may optionally return the status information contained therein to the address controller; Node 1, Node 5, and Node 7 may optionally return their own status information to the address controller.

In this embodiment, Node 1, Node 2, Node 3, Node 4, Node 5, Node 6, and Node 7 are each integrated into a single integrated circuit chip. Alternatively, the address controller may be integrated into a single integrated circuit chip together with one or more of Node 1, Node 5, and Node 7.

The above descriptions are merely preferred implementations of the present invention, but the protection scope of the present invention is not limited thereto. Any changes or substitutions that can be easily conceived by those skilled in the art within the technical scope disclosed by the present invention shall be included in the protection scope of the present invention.

What is claimed is:

1. A node address configuration method for a multi-node system, where the multi-node system comprises a plurality of nodes and an address controller, characterized in that:
the address controller is connected to one or more nodes;
the address controller sends an address configuration command packet to the nodes connected to it, and the address configuration command packet comprises a target node address and a target node configuration address;
each node in the multi-node system is connected to one or more transmission channels and is linked to one or more other nodes through the transmission channels, where each transmission channel has a transmission channel number;
the node includes an address identifier for identifying the address of the node;
the node may optionally include a forwarding table, where the input of the forwarding table is a target node address and the output is a transmission channel number;
the state of the node includes an unconfigured state and a configured state;
the node parses the address configuration command packet: in the unconfigured state, if the target node address in the address configuration command packet is equal to the address identifier of the node, the node configures its address identifier as the target node configuration address in the address configuration command packet; in the configured state, if the target node address is not equal to the address identifier of the node and the node includes a forwarding table, the node queries the forwarding table using the target node address and sends the address configuration command packet to the connected node through the transmission channel indicated by the forwarding table.

2. The node address configuration method for a multi-node system according to claim 1, characterized in that:
in the configured state, if the target node address in the received address configuration command packet is equal to the address identifier of the node, the node configures its address identifier as the target node configuration address in the address configuration command packet.

3. The node address configuration method for a multi-node system according to claim 1, characterized in that:
when the address controller has not configured the address identifier of the node, the node is in the unconfigured state;
when the address controller completes the configuration of the address identifier of the node, the node is in the configured state.

4. The node address configuration method for a multi-node system according to claim 1, characterized in that:
when the address identifier of the node is the default address of the node, the node is in the unconfigured state;
when the address identifier of the node is configured to be different from the default address of the node, the node is in the configured state;
the default addresses of different nodes in the multi-node system may be the same or different.

5. The node address configuration method for a multi-node system according to claim 1, characterized in that:
the method of sending the address configuration command packet to the connected node through the transmission channel indicated by the forwarding table is: if the forwarding table outputs a valid transmission channel number, the address configuration command packet is sent to the connected node through the transmission channel corresponding to the transmission channel number.

6. The node address configuration method for a multi-node system according to claim 1, characterized in that:
the address configuration command packet further includes a source node address, where the source node address is the address identifier of the node connected to the address controller.

7. The node address configuration method for a multi-node system according to claim 6, characterized in that:
after receiving the address configuration command packet, the node may optionally return an address configuration status packet, where the address configuration status packet comprises a target node address of the address configuration status packet and status information, and the target node address of the address configuration status packet is the source node address of the corresponding address configuration command packet;
the node returns the address configuration status packet to the node connected to the address controller;
the node connected to the address controller may optionally return the status information in the address configuration status packet to the address controller connected to it.

8. The node address configuration method for a multi-node system according to claim 7, characterized in that:
in the unconfigured state, if the target node address in the address configuration command packet is equal to the address identifier of the node and the node successfully configures its address identifier as the target node configuration address in the address configuration command packet, the node returns the address configuration status packet with the status information being status information A.

9. The node address configuration method for a multi-node system according to claim 7, characterized in that:
in the unconfigured state, if the target node address in the address configuration command packet is equal to the address identifier of the node and the node fails to configure its address identifier as the target node configuration address in the address configuration command packet, the node returns the address configuration status packet with the status information being status information B.

10. The node address configuration method for a multi-node system according to claim 7, characterized in that:
in the unconfigured state, if the target node address in the address configuration command packet is not equal to the address identifier of the node, the node returns the address configuration status packet with the status information being status information C.

11. The node address configuration method for a multi-node system according to claim 7, characterized in that:
in the configured state, if the target node address in the address configuration command packet is equal to the address identifier of the node and the node successfully configures its address identifier as the target node configuration address in the address configuration command packet, the node returns the address configuration status packet with the status information being status information D.

12. The node address configuration method for a multi-node system according to claim 7, characterized in that:
in the configured state, if the target node address in the address configuration command packet is equal to the address identifier of the node and the node fails to configure its address identifier as the target node configuration address in the address configuration command packet, the node returns the address configuration status packet with the status information being status information E.

13. The node address configuration method for a multi-node system according to claim 7, characterized in that:
in the configured state, if the target node address in the address configuration command packet is not equal to the address identifier of the node and the transmission channel number returned by the node querying the forwarding table using the target node address is invalid, the node returns the address configuration status packet with the status information being status information F.

14. The node address configuration method for a multi-node system according to claim 7, characterized in that:
the method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node queries the forwarding table using the target node address in the address configuration status packet and sends the address configuration status packet to the connected node through the transmission channel indicated by the forwarding table.

15. The node address configuration method for a multi-node system according to claim 7, characterized in that:
the method of the node returning the address configuration status packet to the node connected to the address controller is: the node on the return path of the address configuration status packet parses the address configuration status packet; if the target node address in the address configuration status packet is equal to the address identifier of the node, the node receives the address configuration status packet; if the target node address in the address configuration status packet is not equal to the address identifier of the node, the node forwards the address configuration status packet to the transmission channel through which the node received the address configuration command packet corresponding to the address configuration status packet.

16. The node address configuration method for a multi-node system according to claim 7, characterized in that:
the node connected to the address controller further includes a timeout timer; when the address configuration status packet is not returned to the node before the timeout, the node stops waiting for the address configuration status packet and may optionally return timeout status information to the address controller connected to it.

17. The node address configuration method for a multi-node system according to claim 1, characterized in that:
the address configuration command packet sent by the address controller further includes forwarding table entry configuration information;
the node parses the address configuration command packet: in the unconfigured state, if the target node address in the address configuration command packet is equal to the address identifier of the node, the node configures its address identifier as the target node configuration address in the address configuration command packet and configures the corresponding forwarding table entry according to the comprised forwarding table entry configuration information; in the configured state, if the target node address is not equal to the address identifier of the node, the node queries the forwarding table using the target node address and sends the address configuration command packet to the connected node through the transmission channel indicated by the forwarding table.

18. The node address configuration method for a multi-node system according to claim 17, characterized in that:
in the configured state, if the target node address in the address configuration command packet is equal to the address identifier of the node, the node configures its address identifier as the target node configuration address in the address configuration command packet and configures the corresponding forwarding table entry according to the comprised forwarding table entry configuration information.

19. The node address configuration method for a multi-node system according to claim 1, characterized in that:
the address controller may further send a forwarding table configuration command packet, where the forwarding table configuration command packet comprises a target node address and one or more pieces of forwarding table entry configuration information;
the node parses the forwarding table configuration command packet: in the unconfigured state, if the target node address in the forwarding table configuration command packet is equal to the address identifier of the node, the node configures the corresponding forwarding table entry according to the forwarding table entry configuration information; in the configured state, if the target node address is not equal to the address identifier of the node, the node queries the forwarding table using the target node address and sends the forwarding table configuration command packet to the connected node through the transmission channel indicated by the forwarding table.

20. The node address configuration method for a multi-node system according to claim 19, characterized in that:
in the configured state, if the target node address in the forwarding table configuration command packet is equal to the address identifier of the node, the node configures the corresponding forwarding table entry according to the forwarding table entry configuration information in the forwarding table configuration command packet.

21. The node address configuration method for a multi-node system according to claim 19, characterized in that:
the forwarding table configuration command packet further includes a source node address, where the source node address is the address identifier of the node connected to the address controller.

22. The node address configuration method for a multi-node system according to claim 21, characterized in that:
after receiving the forwarding table configuration command packet, the node may optionally return a forwarding table configuration status packet, where the forwarding table configuration status packet comprises a target node address of the forwarding table configuration status packet and status information, and the target node address of the forwarding table configuration status packet is the source node address of the corresponding forwarding table configuration command packet;
the node returns the forwarding table configuration status packet to the node connected to the address controller;
the node connected to the address controller may optionally return the status information in the forwarding table configuration status packet to the address controller connected to it.

23. The node address configuration method for a multi-node system according to claim 22, characterized in that:
in the unconfigured state, if the target node address in the forwarding table configuration command packet is equal to the address identifier of the node and the node successfully configures the corresponding forwarding table entry according to the forwarding table entry configuration information in the forwarding table configuration command packet, the node returns the forwarding table configuration status packet with the status information being status information A1.

24. The node address configuration method for a multi-node system according to claim 22, characterized in that:
in the unconfigured state, if the target node address in the forwarding table configuration command packet is equal to the address identifier of the node and the node fails to configure the corresponding forwarding table entry according to the forwarding table entry configuration information in the forwarding table configuration command packet, the node returns the forwarding table configuration status packet with the status information being status information B1.

25. The node address configuration method for a multi-node system according to claim 22, characterized in that:
in the unconfigured state, if the target node address in the forwarding table configuration command packet is not equal to the address identifier of the node, the node returns the forwarding table configuration status packet with the status information being status information C1.

26. The node address configuration method for a multi-node system according to claim 22, characterized in that:
in the configured state, if the target node address in the forwarding table configuration command packet is equal to the address identifier of the node and the node successfully configures the corresponding forwarding table entry according to the forwarding table entry configuration information in the forwarding table configuration command packet, the node returns the forwarding table configuration status packet with the status information being status information D1.

27. The node address configuration method for a multi-node system according to claim 22, characterized in that:
in the configured state, if the target node address in the forwarding table configuration command packet is equal to the address identifier of the node and the node fails to configure the corresponding forwarding table entry according to the forwarding table entry configuration information in the forwarding table configuration command packet, the node returns the forwarding table configuration status packet with the status information being status information E1.

28. The node address configuration method for a multi-node system according to claim 22, characterized in that:
in the configured state, if the target node address in the forwarding table configuration command packet is not equal to the address identifier of the node and the transmission channel number returned by the node querying the forwarding table using the target node address is invalid, the node returns the forwarding table configuration status packet with the status information being status information F1.

29. The node address configuration method for a multi-node system according to claim 22, characterized in that:
the method of the node returning the forwarding table configuration status packet to the node connected to the address controller is: the node on the return path of the forwarding table configuration status packet parses the forwarding table configuration status packet; if the target node address in the forwarding table configuration status packet is equal to the address identifier of the node, the node receives the forwarding table configuration status packet; if the target node address in the forwarding table configuration status packet is not equal to the address identifier of the node, the node queries the forwarding table using the target node address in the forwarding table configuration status packet and sends the forwarding table configuration status packet to the connected node through the transmission channel indicated by the forwarding table.

30. The node address configuration method for a multi-node system according to claim 22, characterized in that:
the method of the node returning the forwarding table configuration status packet to the node connected to the address controller is: the node on the return path of the forwarding table configuration status packet parses the forwarding table configuration status packet; if the target node address in the forwarding table configuration status packet is equal to the address identifier of the node, the node receives the forwarding table configuration status packet; if the target node address in the forwarding table configuration status packet is not equal to the address identifier of the node, the node forwards the forwarding table configuration status packet to the transmission channel through which the node received the forwarding table configuration command packet corresponding to the forwarding table configuration status packet.

31. The node address configuration method for a multi-node system according to claim 22, characterized in that:
the node connected to the address controller further includes a timeout timer; when the forwarding table configuration status packet is not returned to the node before the timeout, the node stops waiting for the forwarding table configuration status packet and may optionally return timeout status information to the address controller connected to it.

32. The node address configuration method for a multi-node system according to claim 1, characterized in that:
one node is integrated into a single integrated circuit chip.

33. The node address configuration method for a multi-node system according to claim 1, characterized in that:
the address controller is connected to one node;
the address controller and the node connected to it are integrated into a single integrated circuit chip.
